(19) United States
(12) Patent Application Publication
(10) Pub. No.: US 2012/0008161 A1
(43) Pub. Date: Jan. 12, 2012

(54) AUTOMATED SYSTEM AND METHOD FOR SUBMITTING A RENDERING JOB VIA A MOBILE COMMUNICATIONS DEVICE

(75) Inventor: Joseph Rouhana, Rochester, NY (US)

(73) Assignee: Xerox Corporation

(21) Appl. No.: 12/832,572

(22) Filed: Jul. 8, 2010

(51) Int. Cl. G06F 3/12

(52) U.S. Cl. 358/1.15

(57) ABSTRACT

An automated system and method for submitting a rendering job via a mobile communications device utilizing a two-dimensional bar code application. A two-dimensional bar code (e.g., quick response code) can be configured in association with the rendering device and the two-dimensional bar code application can be installed with respect to the mobile communications device. The bar code can be scanned via an image-capturing unit associated with the mobile communications device for retrieving information required to support an automated workflow utilizing the two-dimensional bar code application. The rendering job can be automatically uploaded to the rendering device based on the automated workflow. Such an approach automatically connects and renders the job via the mobile communications device with no additional hardware requirement.

### TECHNICAL FIELD

Embodiments are generally related to multi-function devices such as, for example, printers, scanners, photocopy machines, etc. Embodiments are also related to mobile rendering techniques. Embodiments are additionally related to methods and systems for submitting a rendering job via a mobile communications device.

### BACKGROUND OF THE INVENTION

Network printing systems generally include an assemblage of varying multifunction devices, client computers, servers, and other components that are connected to and communicate over a network. Multifunction devices include components such as printers, scanners, faxes, copy machines, and so forth. Such network printing system can be communicatively linked with a mobile communications device in order to provide various operations such as, for example, printing, scanning, and other operations within the network.

Examples of mobile communications devices include Smartphones, cellular telephones, iPad type devices, laptop computers, personal digital assistants (PDAs), so-called pocket PCs and other handheld computing devices. Such devices can include a host application that enables the device to operatively communicate with a network printing system. The host application associated with the mobile device provides an abstracted interface between the mobile device and a specific multifunction device to communicate a rendering job including a set of text, graphic, layout commands and so forth.

The majority of prior art approaches for connecting and submitting a rendering job from a mobile device to a multifunction device requires a customized device driver, and, for example, Bluetooth or Wi-Fi connectivity. Additionally, a mobile user can transmit the rendering job from the mobile device to a server via an email. The server further communicates the rendering job to the multifunction device and connects a web enabled command workstation and/or installs an application driver on to the mobile device in order to submit the rendering job.

Such an approach, however, requires the mobile user to manually enter the address information associated with the multifunction device on the mobile device, which places a burden on the mobile user. Such prior art approaches are therefore unable to provide automated mobile-to-print applications in varying mobile rendering applications.

Based on the foregoing, it is believed that a need exist for an improved system and method for automatically submitting a rendering job via a mobile communications device. A need also exists for configuring a two-dimensional bar code in association with the rendering device, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved method and system for configuring a multi-function device (MFD), such as a printer, scanner, photocopy machine, fax machine, etc., or a combination thereof.

It is another aspect of the disclosed embodiment to provide for an improved system and method for submitting a rendering job via a mobile communications device.

It is further aspect of the disclosed embodiment to provide for an improved method for configuring a two-dimensional bar code in association with the rendering device.

The aforementioned aspects and other objectives and advantages can now be achieved as described herein. An automated system and method for submitting a rendering job via a mobile communications device utilizing a two-dimensional bar code application is disclosed herein. A two-dimensional bar code (e.g., quick response code) can be configured in association with the rendering device and the two-dimensional bar code application can be installed with respect to the mobile communications device. The bar code can be scanned via an image capturing unit associated with the mobile communications device for retrieving information required to support an automated workflow (e.g. an e-mail application, a URL of the device controller or a webpage) utilizing the two-dimensional bar code application. The rendering job can be automatically uploaded to the rendering device based on the automated workflow. Such an approach automatically connects and renders the job via the mobile communications device with no additional hardware requirement.

The information associated with the two-dimensional bar code can be employed to launch an email application on the mobile communications device, fill an appropriate address, attach and transmit the rendering job to a mobile print server. The information associated with the two-dimensional bar code also directs a device browser to a uniform resource locator associated with a device controller and uploads the document for rendering. The quick response code can be attached as a hard copy image with respect to the rendering device and/or displayed on a user interface associated with the rendering device. The quick response code generally includes the address information associated with the rendering device and can be dynamically set to include job parameters (e.g., a number of print copies) required to support the automated work flow. The quick response code application further facilitates a mobile device user to download an application driver from a web page in order to automate mobile-to-print rendering.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a rendering device coupled to a data-processing apparatus through a network, in accordance with the disclosed embodiments;

FIG. 2 illustrates a graphical representation of an automated mobile rendering system associated with a network, in accordance with the disclosed embodiments;

FIG. 3 illustrates a block diagram of the mobile rendering system, in accordance with the disclosed embodiments;

FIG. 4 illustrates a high level flow chart of operation illustrating logical operational steps of a method for submitting a rendering job via a mobile communications device utilizing a two-dimensional bar code application, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

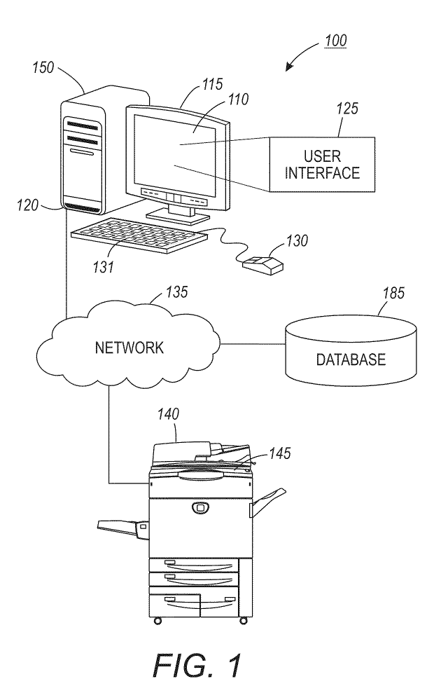

FIG. 1 is provided as an exemplary diagram of data processing environments in which embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environments may be made without departing from the spirit and scope of the present invention.

Referring to FIG. 1, system 100 includes a multi-function device 140 coupled to a data-processing apparatus 110 through a network 135. The data-processing apparatus 110 may be, for example, a personal computer or other computing device, and generally includes a central processor 120, a display device 115, a keyboard 131, and a pointing device 130 (e.g., mouse, track ball, pen device, or the like). Additional input/output devices, such as the multi-function device 140 may be included in association with the data-processing apparatus 110 as desired.

Note that as utilized herein, the term multi-function device (including the acronym MFD) may refer to an apparatus or system such as a printer, scanner, fax machine, copy machine, etc., and/or a combination thereof. Preferably, MFD 140 is capable of multiple rendering functions such as printing, copying, scanning, faxing, etc. In some embodiments, MFD 140 may be implemented with a single rendering function such as printing. In other embodiments, MFD 140 can be configured to provide multiple rendering functions, such as scanning, faxing, printing and copying. Note that the MFD 142 described in greater detail herein is analogous or similar to MFD 140.

A non-limiting example of an MFD that can be utilized as MFD 140 and/or 142 is disclosed in U.S. Pat. No. 7,525,676, entitled “System and Method for Controlling Access to Programming Options of a Multifunction Device,” which issued on Apr. 28, 2009 to Robert J. Pesar. U.S. Pat. No. 7,525,676, which is incorporated herein by reference in its entirety, is assigned to the Xerox Corporation of Norwalk, Conn. Another non-limiting example of an MFD that can be utilized as MFD 140 and/or 142 is disclosed in U.S. Pat. No. 7,474,428, entitled “Multifunction Device System Using Tags Containing Output Information,” which issued on Jan. 6, 2009 to Morris-Jones, et al. U.S. Pat. No. 7,474,428, which is incorporated herein by reference in its entirety, is also assigned to the Xerox Corporation of Norwalk, Conn. An additional example of an MFD that can be utilized as MFD 140 and/or 142 is disclosed in U.S. Pat. No. 5,920,405, entitled “Multifunction Device With Printer Facsimile Contention Selection,” which issued on Jul. 6, 1999 to McIntyre, et al. U.S. Pat. No. 5,920,405, which is incorporated herein by reference in its entirety, is also assigned to the Xerox Corporation of Norwalk, Conn.

The data-processing apparatus 110 can be coupled to the MFD 140 through a computer network 135. Network 135 may employ any network topology, transmission medium, or network protocol. Network 135 may include connections, such as wire, wireless communication links, or fiber optic cables. The MFD 140 includes a user interface 145, such as a panel menu. The panel menu may be used to select features and enter other data in the MFD 140. Such interfaces may include, for example, touch screens having touch activated keys for navigating through an option menu or the like.

A MFD driver program can be installed on the data-processing apparatus 110 and can reside on the host device's hard drive 150. The MFD driver program may be activated through an application interface so that a user may generate a print job with the MFD driver for processing by the MFD 140. The data-processing apparatus 110 also includes a GUI 125 for communicating MFD features for processing, for example, a print job to a user and accepting the user's selection of available MFD features. The user interface 125 displays information and receives data through device display and/or the keyboard/mouse combination. The interface 125, also serves to display results, whereupon the user may supply additional inputs or terminate a given session. The data-processing apparatus 110 can be, for example, any computing device capable of being integrated within a network, such as a PDA, personal computer, cellular telephone, point-of-sale terminal, server, etc.

Note that the user interface as utilized herein generally refers to a type of environment that represents programs, files, options and so forth by means of graphically displayed icons, menus, and dialog boxes on a screen. The input device of the multi-function devices 140 may be a local user interface 125, such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the present invention, which can be embodied in the context of a data-processing apparatus 110 and MFD 140 depicted in FIG. 1. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

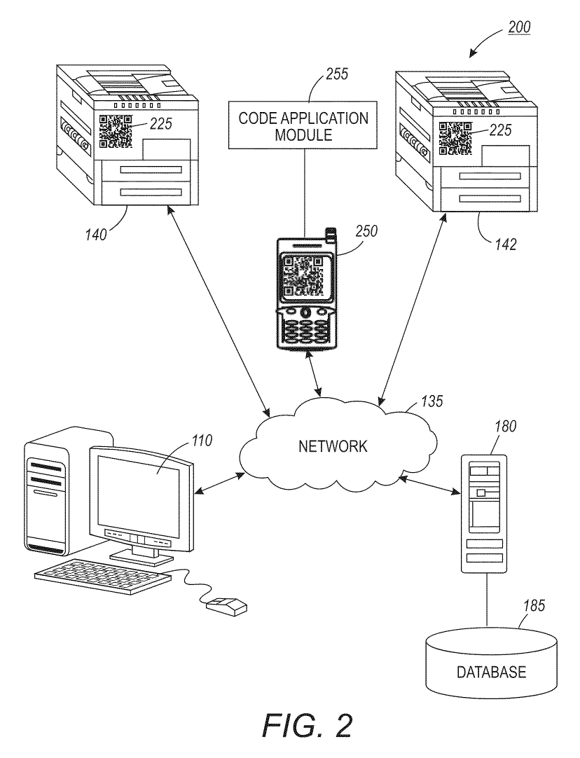

FIG. 2 illustrates a graphical representation of an automated rendering system 200 associated with a network 135, in accordance with the disclosed embodiments. Note that in FIGS. 1-4, identical or similar blocks are generally indicated by identical reference numerals. The automated rendering system 200 generally includes a network infrastructure or network 135 associated with one or more multi-function devices 140 and 142, data-processing system 110, a mobile communications device 250 and a server 240 associated with a database 245.

Note that the mobile communications device (e.g., a cellular telephone, Smartphone, an iPad type device, etc) 250 can communicate directly with the rendering devices 140 and/or 142. The mobile communications device 250 is preferably “located” between the “cloud” or network 135 and the rendering devices 140 and/or 142. In a typical scenario, a user of the mobile communications device 250 walks up to the rendering devices 140 and/or 142 and directly scans the two-dimensional bar code 225 directly displayed on the rendering devices 140 and/or 142. Then, depending on the scenario that takes place, the mobile communications device 250 can communicate with the “cloud” or network 135.

Data-processing system 110 depicted in FIG. 1 can be, for example, a server. Other devices such as, for example, desktops, network devices, palmtops, mobile phones, etc may also be included in the network 135, as service providers. The multi-function devices 140 and 142 can be located remotely with respect to each other, or alternatively, they may be located locally with respect to each other.

The MFD is an office machine, which incorporates the functionality of multiple devices in one, so as to provide centralized document management, document distribution and production in a large-office setting and the like. The typical MFD may act as a combination of a printer, scanner, photocopier, fax and e-mail. While two multi-function devices 140 and 142 are shown by way of example, it is to be appreciated that any number of rendering devices may be linked to the network, such as three, four, six or more rendering devices. In general, the multi-function devices 140 and 142 can be employed to perform a rendering output function (e.g., printing, scanning, copying, faxing, etc) within a networked environment. Note that multi-function devices 140 and 142 are generally analogous to one another.

The multi-function device 140 and 142 can be configured in association with a two-dimensional bar code 225 that includes address information with respect to the multifunction device 140 and 142. In general, the two-dimensional bar code 225 includes a series of stripes (usually black) on a light background (usually white) that can be scanned and read directly into the data-processing system 110. The two-dimensional bar code 225 can be interpreted virtually instantaneously and without errors by a bar code reading unit. The elements (bars and spaces) in a bar code symbol can be of consistent, proportional thickness and thinness. The widest element can be as thick as a pencil or as thin as a business card, as long as the corresponding thin bars and spaces in the bar code 225 remain proportionally thin.

A code application module 255 associated with the mobile communications device 250 can be adapted for executing the functions of the two-dimensional bar code 225. Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as USB drives, Flash memory drives, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

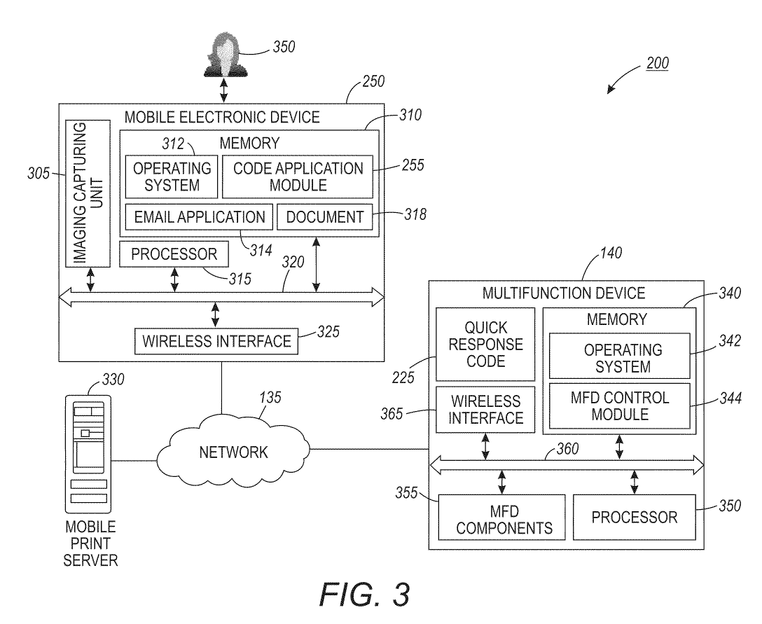

FIG. 3 illustrates a block diagram of the mobile rendering system 200, in accordance with the disclosed embodiments. The mobile rendering system 200 includes the mobile communications device 250, the multifunction device 140, and a mobile printer server 330 that are communicated through the network 135. The mobile communications device 250 can be such as, for example, a Smartphone, a personal digital assistant (PDA), and the like which offers a wide range of capabilities including storing and editing documents, receiving and sending electronic mails and storing/viewing images. The mobile communications device 250 includes an image-capturing unit 305, a memory 310 and a processor 315 coupled to a local interface 320. The image-capturing unit 305 may be generally employed to capture an image of the two-dimensional bar code 225 associated with the multifunction device 140.

The image-capturing unit 305 may include built-in integrated functions such as image processing, data formatting and data compression functions. Additionally, the image-capturing unit 305 includes imager positioning, range finding and a flash bulb. The local interface 320 can be for example, a data bus with an accompanying control/address bus. A wireless interface 325 facilitates wireless communication with the multifunction device 140 and other wireless devices and/or networks. The memory 310 stores several components that are executable by the processor 315. The components include, for example, an operating system 312, an e-mail application 314, one or more documents 318 and the code application module 255.

The multifunction device 140 includes a processor circuit having a memory 340 and a processor 350 coupled to a local interface 360. The memory 340 stores an operating system 342 and a MFD control module 344 that are executable by the processor 350. The multifunction device 140 also includes various MFD components 355 such as motors and mechanical paper path components as well as image creation components. A wireless network interface 365 coupled to the local interface 360 facilitates wireless communication with respect to the multifunction device 140.

The two-dimensional bar code 225 can be configured in association with the multifunction device 140 and the two-dimensional bar code application module 225 can be installed on the mobile communications device 250. The two-dimensional bar code 225 associated with the multifunction device 140 can be for example, a quick response (QR) code, depending upon design considerations. Note that the quick response 225 can be a machine-readable code utilizing either a public standard encoding symbol or a proprietary symbol. The quick response code 225 generally includes varying positioning symbols, apex detecting cells, information recording regions, timing cell regions and format code regions. The quick response code 225 includes address information, blog/website information, email address, or any other normal text with respect to the multifunction device 140. Such information can be encoded and stored as numeric, alphanumeric, binary (8 bits) (or) Kanji/full-width Kana characters.

The quick response code 225 also includes varying other information such as, an IP address and URL that are required to support automated work flow with respect to the multifunction device 140. The quick response code 225 associated with the multifunction device 140 can be attached as a hard copy image and/or displayed on the user interface 145 of the multifunction device 140. The quick response code 225 can be dynamically set to include one or more parameters such as number of copies with respect to the rendering job. The quick response code 225 thus formed can be read by the image capturing unit 305 associated with the mobile device 250 having appropriate decoding software that can photograph and decode the quick response code 225. The quick response code 225 can be scanned via the image capturing unit 305 associated with the mobile device 250 for retrieving information required to support an automated workflow (e.g. an e-mail application, a URL of the device controller or a webpage) utilizing the two-dimensional bar code application 225.

Additionally, the quick response code 225 can inform the mobile device 250 (or multiple mobile devices) of the ways in which the two can be connected via, for example, Infrared communication, Bluetooth wireless communications, Wi-Fi, 3G, etc., and provide protocol assistance for the establishment of such a connection.

Such an approach automatically connects and renders the jobs via the mobile communications device 250 with no additional hardware requirement on the device 250 and 140. Note that the information associated with the two-dimensional bar code 225 can be employed to launch an email application on the mobile communications device 250, fill an appropriate address, attach and transmit the document to the mobile print server 330. The information associated with the two-dimensional bar code 225 also directs a device browser to a uniform resource locator associates with a device controller and uploads the document for rendering. The two-dimensional bar code application module 225 further facilitates a mobile communications device user 350 to download an application driver from a web page in order to automate mobile-to-print rendering.

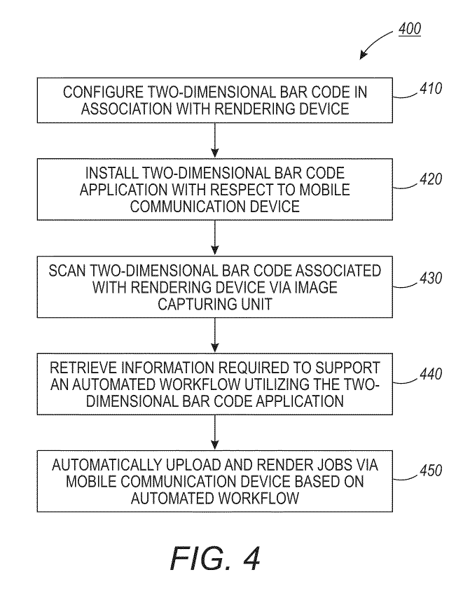

FIG. 4 illustrates a high level flow chart of operation illustrating logical operational steps of a method 400 for submitting the rendering job via the mobile communications device 250 utilizing the two-dimensional bar code 225, in accordance with the disclosed embodiments. The two-dimensional bar code 225 can be configured in association with the rendering device 140, as indicated at block 410. The two-dimensional bar code application module 225 can be installed in association with the mobile communications device 250, as illustrated at block 420. Thereafter, the two-dimensional bar code 225 associated with the multifunction device 140 can be scanned utilizing the image-capturing unit 305, as depicted at block 430. The quick response code 225 includes the address information associated with the multifunction device 140 and can be dynamically set to include job parameters (e.g., a number of print copies) required to support an automated work flow.

Such address information directs the mobile device 250 to a landing page on a website that can automate the process of submitting the rendering job to the multifunction device 140 for rendering via the mobile print server 330 or a web enabled controller. The information required to support an automated workflow utilizing the two-dimensional bar code application 255 can be retrieved, as indicated at block 440. Thereafter, the job can be automatically uploaded and rendered via the mobile communications device 250 based on the automated workflow, as illustrated at block 450. The system and method therefore effectively provides automated print and file submission workflows in varying mobile rendering applications thereby automating mobile-to-print rendering process.

Based on the foregoing it can be appreciated that a method is disclosed for rendering a job via a mobile communications device. An embodiment of such a method can include configuring a two-dimensional bar code in association with a rendering device in order to thereafter install a two-dimensional bar code application with respect to a mobile communications device; scanning the two-dimensional bar code via an image capturing unit associated with the mobile communications device in order to thereafter retrieve information required to support an automated workflow utilizing the two-dimensional bar code application; and uploading a job for rendering based on the automated workflow thereby automatically connecting the job via the mobile communications device with no additional hardware requirement with respect to the mobile communications device.

In another embodiment of such a method the step of configuring the two-dimensional bar code in association with the rendering device can further include attaching the two-dimensional bar code as a hard copy image with respect to the rendering device. In yet another embodiment of such a method, the step of configuring the two-dimensional bar code in association with the rendering device can be further include displaying the two-dimensional bar code on a user interface associated with the rendering device. Another embodiment of such a method can include launching an e-mail application on the mobile communications device in order to thereafter fill an appropriate address with respect to the rendering device; and attaching and transmitting the job to the rendering device via a mobile print server for rendering.

Another embodiment of such a method can also include directing a web browser associated with the mobile communications device to a uniform resource locator in order to upload the job for rendering. Yet another embodiment of such a method can include downloading an application driver from a web page utilizing the two-dimensional bar code application in order to automate mobile-to-print rendering.

It can be appreciated based on the foregoing that another embodiment can include a system for rendering a job via a mobile communications device. Such a system can include, for example, a processor; a data bus coupled to the processor; and a computer-usable medium embodying computer code, the computer-usable medium being coupled to the data bus.

The computer program code can be configured to include instructions executable by the processor and configured for: arranging a two-dimensional bar code in association with a rendering device in order to thereafter install a two-dimensional bar code application with respect to a mobile communications device; scanning the two-dimensional bar code via an image capturing unit associated with the mobile communications device in order to thereafter retrieve information required to support an automated workflow utilizing the two-dimensional bar code application; and uploading a job for rendering based on the automated workflow thereby automatically connecting the job via the mobile communications device with no additional hardware requirement with respect to the mobile communications device.

In some embodiments, the instructions for arranging the two-dimensional bar code in association with the rendering device can be further configured for attaching the two-dimensional bar code as a hard copy image with respect to the rendering device. In other embodiments, the instructions for arranging the two-dimensional bar code in association with the rendering device can be further configured for displaying the two-dimensional bar code on a user interface associated with the rendering device.

In other embodiments, such instructions can be further configured for launching an e-mail application on the mobile communications device in order to thereafter fill an appropriate address with respect to the rendering device; and attaching and transmitting the job to the rendering device via a mobile print server for rendering. In still other embodiments, such instructions can be further configured for directing a web browser associated with the mobile communications device to a uniform resource locator in order to upload the job for rendering. In yet other embodiments, such instructions can be further configured for downloading an application driver from a web page utilizing the two-dimensional bar code application in order to automate mobile-to-print rendering.

In other embodiments, such instructions can be further configured for directing a web browser associated with the mobile communications device to a uniform resource locator in order to upload the job for rendering; and for downloading an application driver from a web page utilizing the two-dimensional bar code application in order to automate mobile-to-print rendering.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for rendering a job via a mobile communications device, said method comprising:
configuring a two-dimensional bar code in association with a rendering device in order to thereafter install a two-dimensional bar code application with respect to a mobile communications device;
scanning said two-dimensional bar code via an image capturing unit associated with said mobile communications device in order to thereafter retrieve information required to support an automated workflow utilizing said two-dimensional bar code application; and
uploading a job for rendering based on said automated workflow thereby automatically connecting said job via said mobile communications device with no additional hardware requirement with respect to said mobile communications device.

2. The method of claim 1 wherein configuring said two-dimensional bar code in association with said rendering device further comprises:
attaching said two-dimensional bar code as a hard copy image with respect to said rendering device.

3. The method of claim 1 wherein configuring said two-dimensional bar code in association with said rendering device further comprises:
displaying said two-dimensional bar code on a user interface associated with the rendering device.

4. The method of claim 1 further comprising:
launching an e-mail application on said mobile communications device in order to thereafter fill an appropriate address with respect to said rendering device; and
attaching and transmitting said job to said rendering device via a mobile print server for rendering.

5. The method of claim 1 further comprising directing a web browser associated with said mobile communications device to a uniform resource locator in order to upload said job for rendering.

6. The method of claim 1 further comprising downloading an application driver from a web page utilizing said two-dimensional bar code application in order to automate mobile-to-print rendering.

7. A system for rendering a job via a mobile communications device, said system comprising:
a processor;
a data bus coupled to said processor; and
a computer-usable medium embodying computer code, said computer-usable medium being coupled to said data bus, said computer program code comprising instructions executable by said processor and configured for:
arranging a two-dimensional bar code in association with a rendering device in order to thereafter install a two-dimensional bar code application with respect to a mobile communications device;
scanning said two-dimensional bar code via an image capturing unit associated with said mobile communications device in order to thereafter retrieve information required to support an automated workflow utilizing said two-dimensional bar code application; and
uploading a job for rendering based on said automated workflow thereby automatically connecting said job via said mobile communications device with no additional hardware requirement with respect to said mobile communications device.

8. The system of claim 7 wherein said instructions for arranging said two-dimensional bar code in association with said rendering device, are further configured for attaching said two-dimensional bar code as a hard copy image with respect to said rendering device.

9. The system of claim 7 wherein said instructions for arranging said two-dimensional bar code in association with said rendering device, are further configured for displaying said two-dimensional bar code on a user interface associated with the rendering device.

10. The system of claim 7 wherein said instructions are further configured for:
launching an e-mail application on said mobile communications device in order to thereafter fill an appropriate address with respect to said rendering device; and
attaching and transmitting said job to said rendering device via a mobile print server for rendering.

11. The system of claim 7 wherein said instructions are further configured for directing a web browser associated with said mobile communications device to a uniform resource locator in order to upload said job for rendering.

12. The system of claim 7 wherein said instructions are further configured for downloading an application driver from a web page utilizing said two-dimensional bar code application in order to automate mobile-to-print rendering.

13. The system of claim 7 wherein said instructions are further configured for:
directing a web browser associated with said mobile communications device to a uniform resource locator in order to upload said job for rendering; and
downloading an application driver from a web page utilizing said two-dimensional bar code application in order to automate mobile-to-print rendering.

14. The system of claim 10 wherein said instructions are further configured for:
directing a web browser associated with said mobile communications device to a uniform resource locator in order to upload said job for rendering; and
downloading an application driver from a web page utilizing said two-dimensional bar code application in order to automate mobile-to-print rendering.

15. A system for rendering a job via a mobile communications device, said system comprising:
a processor;
a data bus coupled to said processor; and
a computer-usable medium embodying computer code, said computer-usable medium being coupled to said data bus, said computer program code comprising instructions executable by said processor and configured for:
arranging a two-dimensional bar code in association with a rendering device in order to thereafter install a two-dimensional bar code application with respect to a mobile communications device;
scanning said two-dimensional bar code via an image capturing unit associated with said mobile communications device in order to thereafter retrieve information required to support an automated workflow utilizing said two-dimensional bar code application;
uploading a job for rendering based on said automated workflow thereby automatically connecting said job via said mobile communications device with no additional hardware requirement with respect to said mobile communications device; and
directing a web browser associated with said mobile communications device to a uniform resource locator in order to upload said job for rendering.

16. The system of claim 15 wherein said instructions for arranging said two-dimensional bar code in association with said rendering device, are further configured for attaching said two-dimensional bar code as a hard copy image with respect to said rendering device.

17. The system of claim 15 wherein said instructions for arranging said two-dimensional bar code in association with said rendering device, are further configured for displaying said two-dimensional bar code on a user interface associated with the rendering device.

18. The system of claim 15 wherein said instructions are further configured for:
launching an e-mail application on said mobile communications device in order to thereafter fill an appropriate address with respect to said rendering device; and
attaching and transmitting said job to said rendering device via a mobile print server for rendering.

19. The system of claim 15 wherein said instructions are further configured for downloading an application driver from a web page utilizing said two-dimensional bar code application in order to automate mobile-to-print rendering.

20. The system of claim 18 wherein said instructions are further configured for downloading an application driver from a web page utilizing said two-dimensional bar code application in order to automate mobile-to-print rendering.
